(19) United States
(12) Patent Application Publication
(10) Pub. No.: US 2015/0360478 A1
(43) Pub. Date: Dec. 17, 2015

(54) PRINTING APPARATUS AND PRINTING METHOD

(71) Applicant: SEIKO EPSON CORPORATION, Tokyo (JP)

(72) Inventor: Yugo HAMAKAWA, Shiojiri-shi (JP)

(21) Appl. No.: 14/734,789

(22) Filed: Jun. 9, 2015

(30) Foreign Application Priority Data
Jun. 12, 2014 (JP) 2014-121219

(51) Int. Cl. B41J 11/00; B41J 25/00

(52) U.S. Cl. CPC B41J 11/002; B41J 25/001

(57) ABSTRACT

A printing apparatus includes a discharge head with nozzles that discharge UV ink that is cured by the radiation of ultra violet rays, a main scan unit that moves the discharge head along a main scanning direction with respect to a target printing medium, a sub-scan unit that moves the discharge head relatively along a sub-scanning direction, and a UV radiation unit, which is provided on a downstream side of the discharge unit in the sub-scanning direction. An amount of radiation of the UV radiation unit in or during a main scan that radiates ultra violet rays from the UV radiation unit without discharging the UV ink from the discharge head is greater than an amount of radiation of the UV radiation unit in or during a main scan that discharges the UV ink from the discharge head, and radiates ultra violet rays from the UV radiation unit.

### CROSS-REFERENCE TO RELATED APPLICATIONS

The present application claims priority to Japanese Patent Application No. 2014-121219, filed Jun. 12, 2014, which is hereby incorporated by reference in its entirety.

### BACKGROUND

1. Technical Field

Embodiments of the present invention relate to a printing apparatus and a printing method.

2. Related Art

An ink jet printer may be used as a printing apparatus. The ink jet printer prints by discharging an ultra violet-curable ink (hereinafter, referred to as a UV (Ultra Violet) ink), which is irradiated with ultra violet rays in order to be cured, onto a target printing medium in liquid droplets. For example, JP-A-2004-188891 discloses an ink jet recording apparatus that has a plurality of recording modes, in which an image recording speed when printing an image on a target printing medium is different, and which is capable of arbitrarily changing the intensity of ultra violet rays with which UV ink is irradiated depending on the image recording speed. Printing apparatuses that are capable of stably obtaining images with excellent bleeding resistance, glossy feeling, and color reproducibility as a result of this kind of configuration, are known.

A printing apparatus (an ink jet printer) that uses UV ink discharges UV ink from a discharge head, and cures the UV ink that is discharged onto a target printing medium by irradiating the UV ink with ultra violet rays. However, in order to completely cure the UV ink, it is necessary to provide a UV radiation unit (a first UV radiation unit) that irradiates discharged UV ink with ultra violet rays at the same time as when the UV ink is discharged onto the target printing medium, and a UV radiation unit (a second UV radiation unit) that irradiates UV ink on a portion on which printing has finished with ultra violet rays. The UV radiation unit irradiates the UV ink with ultra violet rays using a plurality of passes (main scans). For example, in a case of a printing apparatus in which ultra violet rays are radiated from the second UV radiation unit using four main scans after a single line of printing is finished, at a time point at which the discharge of UV ink onto a lower end line of a printing region of a target printing medium is finished, the UV ink that is discharged on a lowermost end line of a printing region has not received a sufficient amount of radiation of ultra violet rays. Therefore, in the printing apparatus that is disclosed in JP-A-2004-188891, in order to completely cure the UV ink in a lowermost end line, it is necessary to perform a main scan (referred to as a lower end process) four times in order to radiate ultra violet rays only without discharging UV ink from the discharge head in order to fully cure the discharged UV ink. In other words, it is necessary to perform main scans after the discharge of UV ink onto a target printing medium has finished such that the UV ink can be sufficiently radiated with ultra violet rays. As a result of this, there is a problem in that a time that is required for the lower end process to be performed is long, and therefore, a processing capacity of the printing apparatus is deteriorated.

### SUMMARY

Embodiments of the invention can be realized in the following forms or application examples.

### Application Example 1

According to this application example, a printing apparatus is provided that includes a discharge head, in which nozzles that discharge UV ink, which is cured by the radiation of ultra violet rays, are formed, a main scan unit that moves the discharge head relatively along a main scanning direction with respect to a target printing medium, a sub-scan unit that moves the discharge head relatively along a sub-scanning direction, which is a direction that intersects the main scanning direction, with respect to the target printing medium, and a UV radiation unit. The UV radiation unit is provided on a downstream side of the discharge unit in the sub-scanning direction. In one example, an amount of radiation of the UV radiation unit in (or during) a main scan that radiates ultra violet rays from the UV radiation unit without discharging the UV ink from the discharge head is greater than an amount of radiation of the UV radiation unit in (or during) a main scan that discharges the UV ink from the discharge head, and radiates ultra violet rays from the UV radiation unit. In one example, the amount of radiation emitted by the UV radiation unit during a main scan may be greater when UV ink is not discharged that during a main scan when UV ink is discharged.

According to the present application example, the printing apparatus is provided with a UV radiation unit. The UV radiation unit is provided on a downstream side of the discharge head. The UV radiation unit can increase an amount of radiation of the ultra violet rays that is radiated to the UV ink after the UV ink is discharged onto the target printing medium from the discharge head. After the discharge of the UV ink onto the target printing medium is finished, in the lower end process in which ultra violet rays are radiated to UV ink, which is discharged onto a lowermost end line, it is possible to reduce a number of main scans (the number of lower end process) for radiating ultra violet rays by performing a main scan that relatively moves the discharge head and the target printing medium and by increasing an amount of radiation per unit time of the ultra violet rays that are emitted or discharged from the UV radiation unit, and driving the main scan unit without discharging UV ink from a discharge head. As a result of this, a time that is required to perform the lower end process is reduced, and therefore, it is possible to improve a processing capacity of the printing apparatus. Therefore, it is possible to provide a printing apparatus with an improved printing processing capacity.

### Application Example 2

In the printing apparatus according to the application example, the UV radiation unit includes a light emitting element. An amount of radiation of the ultra violet rays is increased by increasing a light emission amount of the light emitting element.

According to the present application example, because the UV radiation unit includes a light emitting element, which outputs ultra violet rays, it is possible to increase the light emission amount of ultra violet rays by increasing a current of a power source that drives the light emitting element. As a result of this, it is possible to easily increase an amount of radiation of the ultra violet rays.

### Application Example 3

In the printing apparatus according to the application example, the UV radiation unit includes a plurality of light emitting elements, and an amount of radiation of the ultra violet rays is increased by increasing an element number of the light emitting elements.

According to the present application example, the UV radiation unit includes a plurality of light emitting elements, which output ultra violet rays, and it is possible to easily increase an amount of radiation of the ultra violet rays by increasing an element number of the light emitting elements that are driven.

### Application Example 4

In the printing apparatus according to the application example, the UV radiation unit includes a radiation light source that radiates the ultra violet rays in or during the main scan in which UV ink is not discharged.

According to the present application example, the UV radiation unit is provided with a radiation light source for the lower end process that radiates ultra violet rays during or in the main scan that does not discharge UV ink. It is possible to reduce a time that is required to perform or complete the lower end process by driving the radiation light source for the lower end process.

### Application Example 5

In the printing apparatus according to the application example, a number of scans of a main scan in which an amount of radiation of the ultra violet rays is increased by n times, and which radiates ultra violet rays from the UV radiation unit without discharging the UV ink, is decreased by 1/n. In other words, increasing the amount of radiation during a main scan can reduce the total number of main scans that would otherwise be required.

According to the present application example, by increasing an amount of radiation per unit time of the ultra violet rays, with which UV ink that is discharged onto the line of the lowermost end of a printing region is radiated, by four times, for example, it is possible to reduce the number of scans of a main scan that is performed in lower end process by ¼. In other words, in a case in which four main scans are required in the lower end process, it is possible to complete the lower end process with one main scan. As a result of this, a time that is required for the lower end process is reduced, and therefore, it is possible to improve a processing capacity of the printing apparatus.

### Application Example 6

According to this application example, printing method in provided in which printing is performed using a printing apparatus including a discharge head, in which nozzles that discharge UV ink, which is cured by the radiation of ultra violet rays, are formed, a main scan unit that moves the discharge head relatively along a main scanning direction with respect to a target printing medium, a sub-scan unit that moves the discharge head relatively along a sub-scanning direction, which is a direction that intersects the main scanning direction, with respect to the target printing medium, and a UV radiation unit, which is provided on a downstream side of the discharge unit in the sub-scanning direction. The printing method may include increasing an amount of radiation of the ultra violet rays that are radiated from the UV radiation unit, and performing a main scan without discharging the UV ink from the discharge head.

According to the present application example, the printing method of the printing apparatus may include increasing an amount of radiation per unit time of the ultra violet rays, which are radiated from the UV radiation unit, and performing a main scan for radiating ultra violet rays without discharging the UV ink onto the target printing medium, onto which the UV ink has been discharged, from the discharge head. After the discharge of the UV ink onto the target printing medium is finished, in the lower end process in which ultra violet rays are radiated to UV ink, which is discharged onto a lowermost end line, by increasing an amount of radiation of the ultra violet rays, which is radiated from the UV radiation unit, and performing a main scan that moves the discharge head and the target printing medium relatively by driving the main scan unit without discharging UV ink from the discharge head, it is possible to reduce a number of main scans (a number of lower end processes) for radiating the ultra violet rays. As a result of this, a time that is required for the lower end process is reduced, and therefore, it is possible to improve a processing capacity of the printing apparatus. Therefore, it is possible to provide a printing method that improves the processing capacity of the printing apparatus.

Embodiments of the invention thus improve the throughput and processing capacity of the printing apparatus by reducing the time required to cure the UV ink after the discharging process is completed. This can be achieved by increasing the amount of UV rays radiated, increasing a current of a power source, increasing a number of UV elements in the UV unit, or the like or any combination thereof.

### BRIEF DESCRIPTION OF THE DRAWINGS

Embodiments of the invention will be described with reference to the accompanying drawings, wherein like numbers reference like elements.

FIG. 1 is a perspective view that shows an overall configuration of a printing apparatus according to an embodiment.

FIG. 2 is a cross-sectional view of a support stage at a line II-II in FIG. 1.

FIG. 3 is a perspective view that shows the inside of a printing process unit in FIG. 1.

FIG. 4 is a lateral view that shows the inside of the printing process unit in FIG. 1.

FIG. 5 is a plan view that shows a bottom surface of a printing unit in FIG. 4.

FIG. 6 is an explanatory drawing that show a printing method of a case in which printing is initiated from an upper end of a printing region.

FIG. 7 is an explanatory drawing that show a printing method of a case in which printing is finished at a lower end of the printing region.

FIG. 8 is a plan view that shows a bottom surface of a printing unit according to modification example 1.

FIG. 9 is a plan view that shows a bottom surface of a printing unit according to modification example 2.

### DESCRIPTION OF EXEMPLARY EMBODIMENTS

Hereinafter, embodiments of the invention will be described with reference to the drawings. Additionally, in each of the following drawings, in order to make each layer and each member have a size of an extent that can be clearly recognized in the drawing, the scale of each layer and each member has been changed from a practical scale.

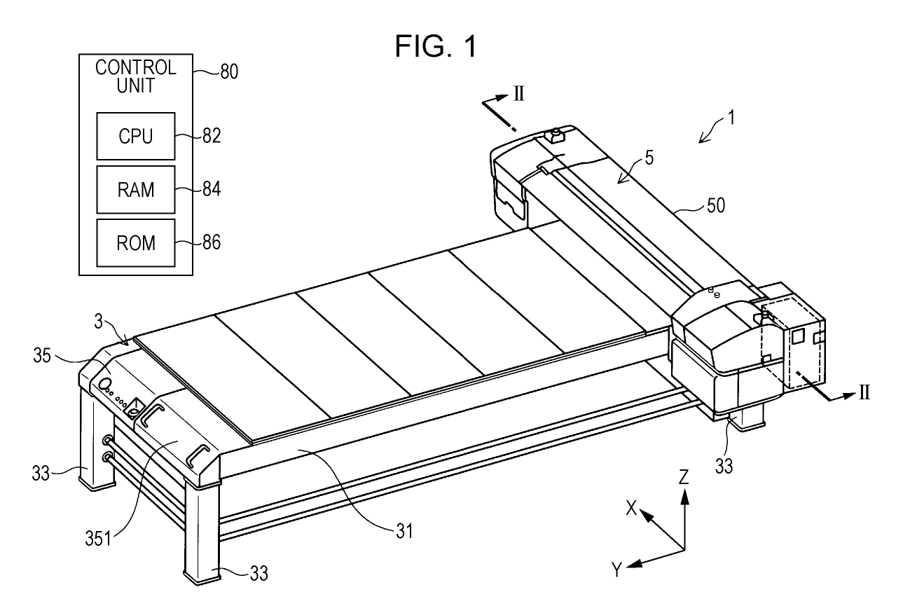

In addition, in FIGS. 1 to 5, FIG. 8 and FIG. 9, for the purpose of description, an X axis, a Y axis, and a Z axis are shown as three axes that mutually intersect one another, leading end sides of arrows that illustrate axial directions are set as “+ sides”, and base end sides thereof are set as “− sides”. In addition, hereinafter, a direction that is parallel to the X axis is referred to as an “X axis direction” or a “main scanning direction”, a direction that is parallel to the Y axis is referred to as a “Y axis direction” or a “sub-scanning direction”, and a direction that is parallel to the Z axis is referred to as a “Z axis direction”.

### Embodiment

### Printing Apparatus

FIG. 1 is a schematic perspective view that shows an overall configuration of a printing apparatus 1 according to one embodiment.

Firstly, an overall configuration of the recording apparatus 1 according to one embodiment will be described using FIG. 1.

As shown in FIG. 1, the printing apparatus 1 is configured to include a printing process unit 5 that is covered by a housing member 50, a support stage 3, an operational panel 35, an opening and closing door 351, leg sections 33, and a control unit 80 that is provided inside the printing apparatus 1. The printing apparatus 1, in one embodiment, is an ink jet printer that performs recording of characters, graphics, images and the like by discharging UV ink onto a target printing medium in liquid droplets.

The printing apparatus 1 is a so-called flatbed type printer, and the printer performs printing by discharging an ultra violet curable ink (UV ink), which is cured by the radiation of ultra violet rays from the printing process unit 5, onto a target printing medium that is horizontally supported by the support stage 3. It is possible to use paper, fabric, film, metal or the like as the target printing medium.

The control unit 80 includes a CPU 82 (Central Processing Unit) that executes various computation processes, a RAM (Random Access Memory) 84 that performs temporary storage and saving of programs and data, and a ROM (Read Only Memory) 86 that stores programs, and the like, that the CPU 82 executes. Various functions of the control unit 80 are realized as a result of the CPU 82 operating on the basis of programs that are stored in the ROM 86. Additionally, at least a portion of the functions of the control unit 80 may be realized as a result of an electrical circuit, which the control unit 80 is provided with, operating on the basis of a circuit configuration thereof.

The support stage 3 forms a substantial flat plate shape, which is longer in the Y axis direction (the sub-scanning direction) than the X axis direction (the main scanning direction). During printing, the target printing medium is disposed on the support stage 3. A plurality of suction holes (not shown in the drawings) are provided on a mounting surface 31 of the support stage 3, which is in contact with the target printing medium, and it is possible to retain the target printing medium on the mounting surface by suctioning the target printing medium to the support stage 3. Additionally, the retention method of the target printing medium is merely an example, and embodiments of the invention are not limited to this.

The leg sections 33 are provided at four corners of the support stage 3, and support the support stage 3. A beam that improves strength by connecting respective leg sections 33, and a caster for easily moving the printing apparatus 1 may also be provided.

The operational panel 35 is an input device for receiving instructions from an operator. The opening and closing door 351 is an input device for an operator to perform maintenance on the printing process unit 5 manually. By moving the printing process unit 5 directly above (in a +Z axis direction) the opening and closing door 351, it is possible for an operator to open the opening and closing door 351, and perform maintenance inside the printing process unit 5 manually.

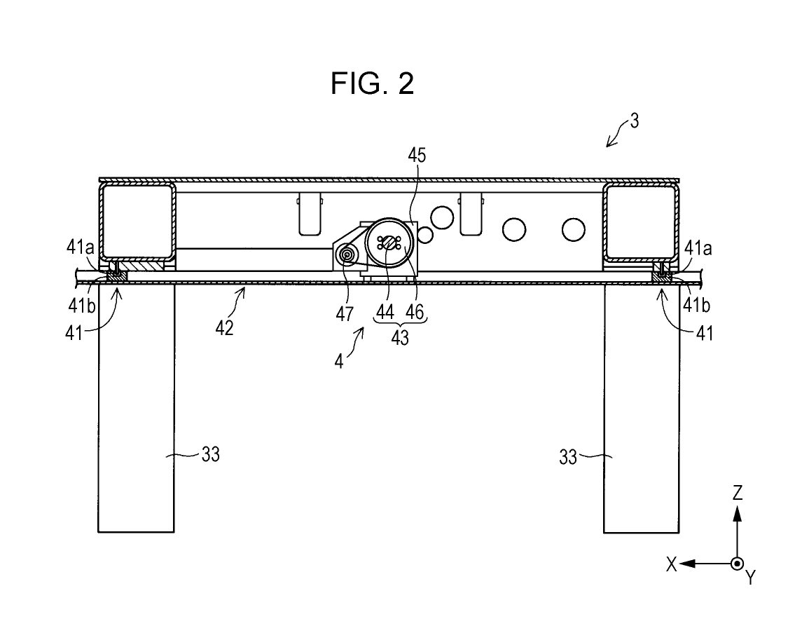

FIG. 2 is a cross-sectional view of a case in which the support stage 3 is sectioned at a line II-II in FIG. 1. Additionally, in FIG. 2, the illustration of the printing process unit 5, which is attached to a connection frame 42, which will be described later, has been omitted. As shown in FIG. 2, the support stage 3 is provided with a sub-scan unit 4 that performs sub-scanning by moving a discharge head 8, which will be described later, relatively along the sub-scanning direction (the Y axis direction) that intersects the main scanning direction (the X axis direction) with respect to the target printing medium. The sub-scan unit 4 is provided with a pair of guide mechanisms 41, which are provided on both sides of the support stage 3 in the main scanning direction (the X axis direction), a connection frame 42, which connects the printing process unit 5 (refer to FIG. 1), which is not shown in the drawing, and the guide mechanisms 41, and a sub-scan driving mechanism 43 that drives the printing process unit 5 (refer to FIG. 1), which is not shown in the drawing, along the guide mechanisms 41 in the sub-scanning direction (the Y axis direction).

In the present embodiment, the guide mechanisms 41 are configured by Linear Motion Guides (LM Guides) (registered trademark). The guide mechanisms 41 are provided with a guide rail 41a that is fixed to a lower side of the support stage 3 running in the sub-scanning direction (the Y axis direction), and a slider 41b that slides in the sub-scanning direction (the Y axis direction) with respect to the guide rail 41a. The slider 41b is attached to the printing process unit 5 (refer to FIG. 1), which is not shown in the drawing, through the connection frame 42.

The sub-scan driving mechanism 43 is provided with a screw shaft 44 that is fixed to the support stage 3 running in the sub-scanning direction (the Y axis direction), a nut member 46 that engages with the screw shaft 44, a sub-scan motor 47 that causes the nut member 46 to rotate, and a support member 45, which is attached to the connection frame 42, and is attached so that the nut member 46 is freely rotatable. In addition to the connection frame 42, the sub-scan unit 4 can move the printing process unit 5 (refer to FIG. 1), which is not shown in the drawing, in the sub-scanning direction (the Y axis direction) by the sub-scan monitor 47 causing the nut member 46 to rotate.

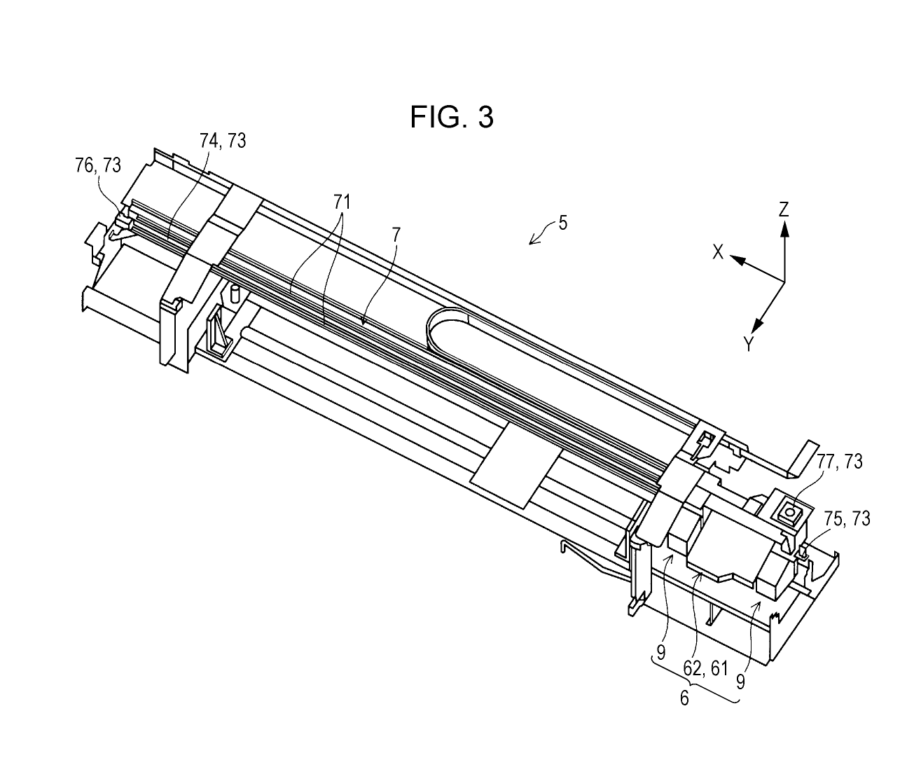

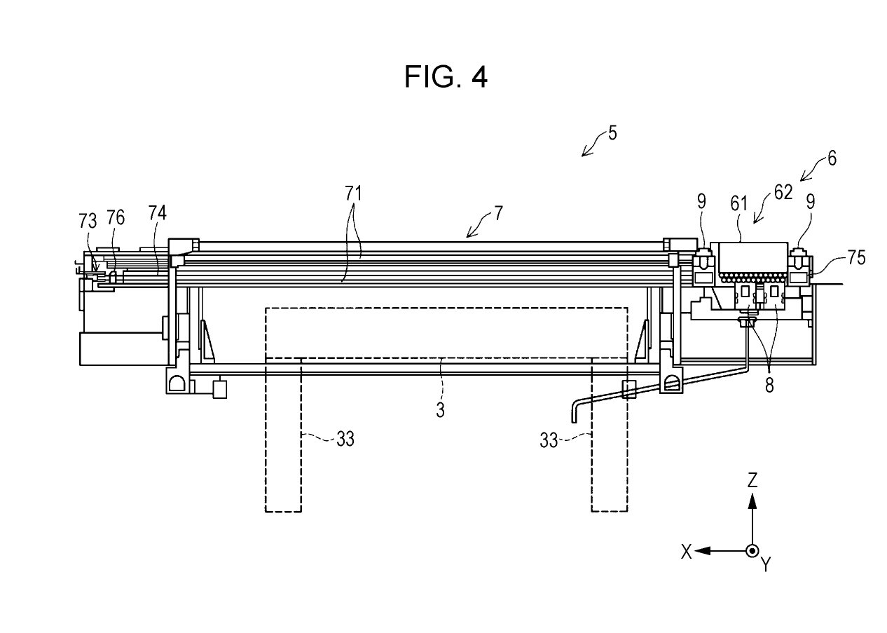

FIG. 3 is a perspective view that shows the inside of the printing process unit 5 in FIG. 1. FIG. 4 is a lateral view that shows the inside of the printing process unit 5 in FIG. 1. Additionally, in FIG. 3, for the purpose of description, the housing member 50 (refer to FIG. 1) is shown as being transparent. As shown in FIG. 3 and FIG. 4, the printing process unit 5 includes a printing unit 6 that is equipped with the discharge head 8 and the like, the main scan unit 7 that performs main scanning by moving the discharge head 8 relatively along the main scanning direction (the X axis direction) with respect to the target printing medium, and the housing member 50 (refer to FIG. 1), which is not shown in the drawing, that stores the printing unit 6 and the main scan unit 7.

The main scan unit 7 includes a top and bottom pair of guide shafts 71 that support the printing unit 6 such that the printing unit 6 is moveable in the main scanning direction (the X axis direction), and a main scan driving mechanism 73 that makes it possible for the printing unit 6 to move along the guide shafts 71.

The main scan driving mechanism 73 includes a timing belt 74 that runs along the guide shafts 71 in the main scanning direction (the X axis direction), a lead pulley 75 and a driven pulley 76 for bridging the timing belt 74, and a main scan motor 77 that drives the lead pulley 75. The main scan unit 7 can move the printing unit 6, which is connected to the timing belt 74, in the main scanning direction (the ±X axis directions). The main scan motor 77 drives the lead pulley 75.

The printing unit 6, which is provided in the printing process unit 5, includes a carriage unit 62 that is equipped with the discharge head 8 in a box-shaped carriage 61, and a UV radiation unit 9 that is respectively fixed to both sides of the carriage unit 62 in the main scanning direction (the X axis direction). Nozzles, which discharge UV ink vertically downwards (in the −Z axis direction) toward a target printing medium, are formed in the discharge head 8.

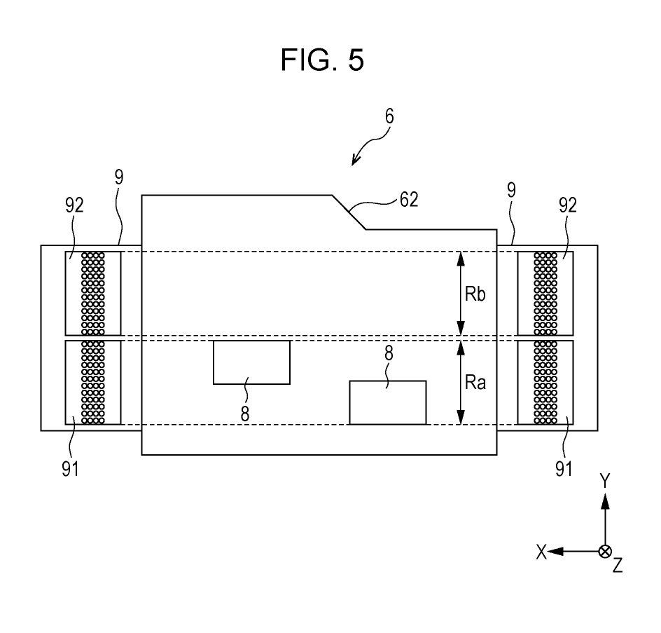

FIG. 5 is a plan view that shows a bottom surface (a −Z axis side) of the printing unit 6 in FIG. 4. The discharge head 8, which is provided in the printing unit 6, is equipped with a plurality of ink cartridges, in which UV ink of predetermined colors (for example, cyan (C), magenta (M), yellow (Y) and black (K)) is respectively stored. The UV ink that is stored in the ink cartridges is supplied to the discharge head 8. In addition, the discharge head 8 includes a plurality of nozzles that discharge UV ink, and an actuator (a nozzle actuator) that is provided to correspond to each nozzle. As a nozzle actuator, it is possible to use a piezo method or device, a thermal method or device or the like.

The discharge head 8 opposes a region Ra that has a predetermined width in the sub-scanning direction (the Y axis direction). An image is printed in the region Ra by discharging UV ink onto the region Ra while moving parallel to the main scanning direction (the X axis direction).

The UV radiation unit 9 includes a UV radiation unit 91 and a UV radiation unit 92 that irradiate the UV ink with ultra violet rays. In the present embodiment, for the purpose of description, the UV radiation unit 91 will be referred to as a first UV radiation unit, and the UV radiation unit 92 will be referred to as a second UV radiation unit. The first UV radiation unit 91 is provided along the main scanning direction with respect to the discharge head 8. More specifically, the first UV radiation unit 91 is provided in a position that is aligned with the carriage unit 62, which is equipped with the discharge head 8, in the X axis direction (the main scanning direction) in the plan view from the −Z axis direction. Since the discharge head 8 performs main scanning in the ±X axis direction, the first UV radiation unit 91 is provided on both sides of the discharge head 8 (the carriage unit 62) in the ±X axis direction. The first UV radiation unit 91 irradiates a region that overlaps with the region Ra with ultra violet rays.

The second UV radiation unit 92 is provided further on a downstream side (a +Y axis side) than the discharge head 8 in the sub-scanning direction (the Y axis direction), and irradiates a region that overlaps with a region Rb with ultra violet rays. Additionally, in FIG. 5, the second UV radiation unit 92 is shown in a form of one second UV radiation unit 92 being provided on a downstream side of each of two first UV radiation units 91, but the configuration thereof is not limited to this. The second UV radiation unit 92 may be disposed further on a downstream side than the discharge head 8 in the sub-scanning direction (the Y axis direction).

By disposing the first UV radiation unit 91 and the second UV radiation unit 92 in this manner, UV ink that is positioned in the region Ra is irradiated with ultra violet rays from the first UV radiation unit 91, and is cured (temporary or partial hardening) at a sufficiently slower extent or rate than a case in which wet extension on the target printing medium is not radiated with ultra violet rays. In other words, the ultra violet rays from the first UV radiation unit 91 slow the extension of the UV ink. When UV ink that is positioned in the region Ra moves into the region Rb as a result of subsequent sub-scanning, the UV ink is irradiated with ultra violet rays from the second UV radiation unit 92, and is cured (main hardening) at an extent at which wet extension on the target printing medium is stopped. Thus, the second UV radiation unit 92 may fully cure the UV ink and stop the extension of the UV ink on the target printing medium.

The printing apparatus 1 performs printing by discharging UV ink onto the target printing medium from the discharge head 8 while repeating a main scan and a sub-scan. UV ink that is discharged onto the target printing medium repeatedly receives the radiation of ultra violet rays from the first UV radiation unit 91 and the second UV radiation unit 92. As a result of this, it is possible to perform main hardening of the UV ink.

As a light source of the first UV radiation unit 91 and the second UV radiation unit 92, a Light Emitting Diode (LED) may be used as a light emitting element. A light emitting element that is used in the second UV radiation unit 92 of the present embodiment is capable of increasing a light emission amount depending on a current that is applied thereto, and as a result of this, it is possible to increase an amount of radiation of the ultra violet rays with which the UV ink is irradiated. Additionally, a configuration that uses an LED as the light source of the first UV radiation unit 91 and the second UV radiation unit 92 has been described, but as long as the light source radiates ultra violet rays, the light source may be used and a light source such as a metal halide lamp, for example, may be used. A light source that is able to cure the UV ink may be used.

### Printing Method (Upper End Section)

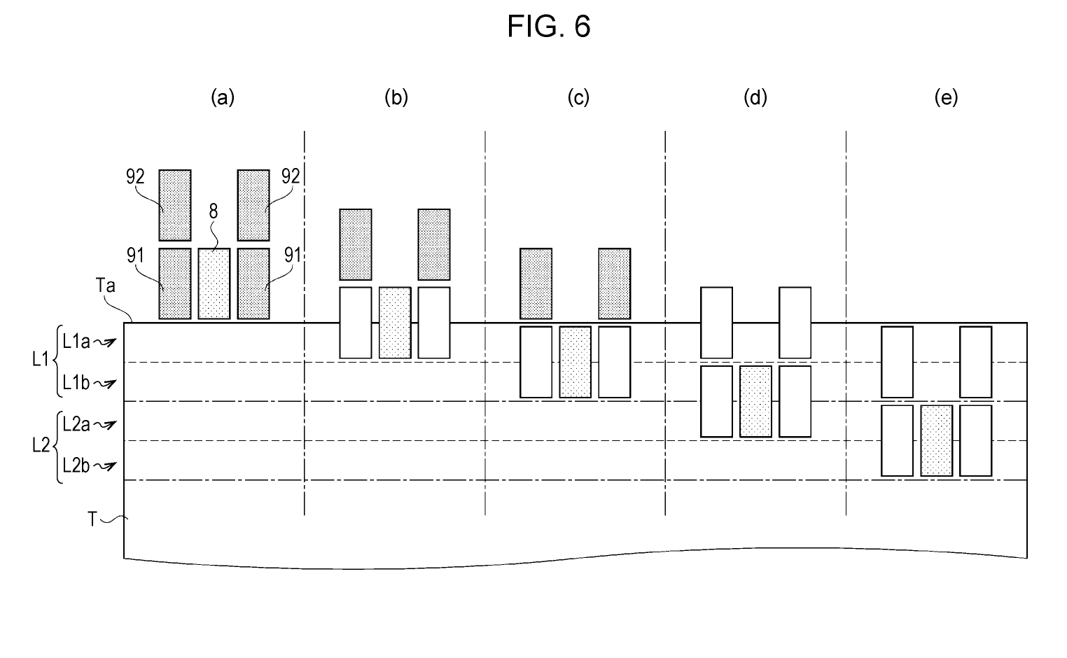

Parts (a) to (e) of FIG. 6 are explanatory drawings that show a printing method of a case in which printing is initiated from an upper end Ta of a printing region T. Parts (a) to (e) of FIG. 6 are states in which the carriage unit 62 of FIG. 5 is viewed from a paper surface rear side (the +Z axis side) of FIG. 5. Additionally, in the present embodiment, in order to simplify the description, the invention has a single discharge head 8, and as an example of a printing method, a case in which one line is printed and irradiated with ultra violet rays using two passes (main scans), and UV ink after printing is irradiated with ultra violet rays using two passes (main scans), is shown. In addition, in the following figures, first UV radiation units 91 and second UV radiation units 92 that are shown as white represent a state of radiating ultra violet rays.

When the discharge head is moving in the main scan direction, UV light may be emitted by the first UV radiation unit 91 and/or the second UV radiation unit 92. During the same main scan, the discharge head may or may not discharge UV ink. As discussed in more detail with respect to FIG. 6. main scans may be required after it is no longer necessary to discharge UV ink. Embodiments of the invention can reduce the number of main scans, during which UV light is radiated, to fully cure the ink that has already been discharged. This may be done, by way of example only, by increasing the radiation. Radiation can be increased by increasing a power, increasing a number of UV elements, or the like or combination thereof.

Part (a) of FIG. 6 shows a positional relationship in the sub-scanning direction between the discharge head 8 and the printing region T in a case in which the carriage unit 62 is moved to an upper end Ta of a printing region T. The printing region T is a region upon which printing is carried out on the target printing medium that is mounted on the support stage 3. The control unit 80 (refer to FIG. 1) determines whether or not it is in a printing region on the basis of a pass number from the initiation of printing. Additionally, the control unit 80 (refer to FIG. 1) may determine whether or not it is in a printing region by providing a camera in the carriage unit 62.

Part (b) of FIG. 6 shows a positional relationship in the sub-scanning direction between the discharge head 8 and the printing region T in a case of performing printing and the radiation of ultra violet rays of a first pass on L1a of a line L1. The control unit 80 (refer to FIG. 1) moves the discharge head 8 relatively to a position that overlaps with L1a of the line L1 of the printing region by performing a sub-scan. Next, the control unit 80 (refer to FIG. 1) performs a main scan by discharging UV ink from the discharge head 8, and radiating ultra violet rays from the first UV radiation unit 91. As a result of this, printing of the first pass and the radiation of ultra violet rays from the first UV radiation unit 91 of the first pass are performed on L1a of the line L1.

Part (c) of FIG. 6 shows a positional relationship in the sub-scanning direction between the discharge head 8 and the printing region T in a case of performing printing and the radiation of ultra violet rays of a second pass on L1a of the line L1. The control unit 80 (refer to FIG. 1) moves the discharge head 8 relatively to a position that overlaps with L1a and L1b of the line L1 of the printing region T by performing a sub-scan. Next, the control unit (refer to FIG. 1) performs a main scan by discharging UV ink from the discharge head 8, and radiating ultra violet rays from the first UV radiation unit 91. As a result of this, printing of the second pass and the radiation of ultra violet rays from the first UV radiation unit 91 of the second pass are performed on L1a of the line L1. Printing and the radiation of ultra violet rays of a first pass are performed simultaneously on L1b of the line L1.

Part (d) of FIG. 6 shows a positional relationship in the sub-scanning direction between the discharge head 8 and the printing region T in a case of performing the radiation of ultra violet rays of a third pass on L1a of the line L1 for which printing is finished. The control unit 80 (refer to FIG. 1) moves the discharge head 8 relatively to a position that overlaps with L2a of a line L2 and L1b of the line L1 of the printing region T by performing a sub-scan. Next, the control unit 80 (refer to FIG. 1) performs a main scan by discharging UV ink from the discharge head 8, and radiating ultra violet rays from the first UV radiation unit 91 and the second UV radiation unit 92. As a result of this, the radiation of ultra violet rays of a third pass from the second UV radiation unit 92 is performed on UV ink that is printed on L1a of the line L1. Printing and the radiation of ultra violet rays of a second pass are performed simultaneously on L1b of the line L1, and printing and the radiation of ultra violet rays of a first pass are performed simultaneously on L2a of the line L2.

Part (e) of FIG. 6 shows a positional relationship in the sub-scanning direction between the discharge head 8 and the printing region T in a case of performing the radiation of ultra violet rays of a fourth pass on L1a of the line L1 for which printing is finished. The control unit 80 (refer to FIG. 1) moves the discharge head 8 relatively to a position that overlaps with L2b of the line L2 and L2a of the line L2 of the printing region T by performing a sub-scan. Next, the control unit 80 (refer to FIG. 1) performs a main scan by discharging UV ink from the discharge head 8, and radiating ultra violet rays from the first UV radiation unit 91 and the second UV radiation unit 92. As a result of this, the radiation of ultra violet rays of the fourth pass from the second UV radiation unit 92 is performed on UV ink that is printed on L1a of the line L1, and the UV ink is completely cured. The radiation of ultra violet rays from the second UV radiation unit 92 of a third pass is performed simultaneously on UV ink that is printed on L1b of the line L1, printing and the radiation of ultra violet rays of a second pass are performed simultaneously on L2a of the line L2, and printing and the radiation of ultra violet rays of a first pass are performed simultaneously on L2b of the line L2.

As described for the printing on L1a of the line L1, the printing by the printing apparatus 1 of the present embodiment performs two passes of printing while radiating ultra violet rays from the first UV radiation unit 91, and completely cures UV ink by further performing two passes of radiating with ultra violet rays from the second UV radiation unit 92. After part (e) of FIG. 6, images and the like are sequentially printed on the target printing medium, and UV ink that is discharged onto the target printing medium is sequentially cured as a result of the control unit (refer to FIG. 1) performing repetitions of a main scan that discharges UV ink from the discharge head 8, and radiates ultra violet rays from the first UV radiation unit 91 and the second UV radiation unit 92, and a substrate-scan.

### Printing Method (Lower End Section)

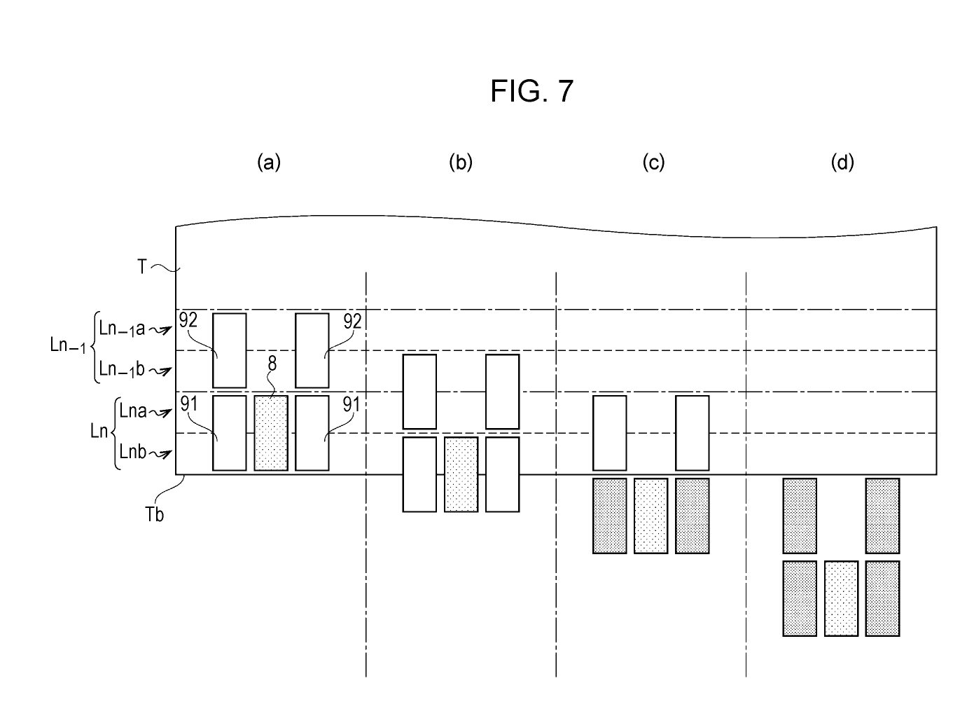

Parts (a) to (d) of FIG. 7 are explanatory drawings that show a printing method of a case in which printing is finished at a lower end Tb of the printing region T.

Part (a) of FIG. 7 shows a positional relationship in the sub-scanning direction between the discharge head 8 and the printing region T in a case of performing printing and the radiation of ultra violet rays of a first pass on Lnb of a line Ln. The control unit 80 (refer to FIG. 1) performs a main scan by discharging UV ink from the discharge head 8, and radiating ultra violet rays from the first UV radiation unit 91 and the second UV radiation unit 92. As a result of this, printing and the radiation of ultra violet rays of a first pass are performed on Lnb of the line Ln. Printing and the radiation of ultra violet rays of a second pass are performed simultaneously on Lna of the line Ln, the radiation of ultra violet rays from the second UV radiation unit 92 of a third pass is performed simultaneously on UV ink that is printed Ln₋₁b of a line Ln₋₁, and the radiation of ultra violet rays from the second UV radiation unit 92 of a fourth pass is performed simultaneously on UV ink that is printed Ln₋₁a of the line Ln₋₁.

Part (b) of FIG. 7 shows a positional relationship in the sub-scanning direction between the discharge head 8 and the printing region T in a case of performing printing and the radiation of ultra violet rays of a second pass on Lnb of the line Ln. The control unit 80 (refer to FIG. 1) moves the discharge head 8 relatively to a position that overlaps with Lnb of the line Ln of the printing region T and that does not overlap with Lna of the line Ln by performing a sub-scan. Next, the control unit 80 (refer to FIG. 1) performs a main scan by discharging UV ink onto Lnb of the line Ln from the discharge head 8, and radiating ultra violet rays from the first UV radiation unit 91 and the second UV radiation unit 92. As a result of this, printing and the radiation of ultra violet rays of the second pass are performed on Lnb of the line Ln. The radiation of ultra violet rays from the second UV radiation unit 92 of a third pass is performed simultaneously on UV ink that is printed on Lna of the line Ln, and the radiation of ultra violet rays from the second UV radiation unit 92 of a fourth pass is performed simultaneously on UV ink that is printed on Ln₋₁b of the line Ln₋₁.

Part (c) of FIG. 7 shows a positional relationship in the sub-scanning direction between the discharge head 8 and the printing region T in a case of irradiating Lna and Lnb of the line Ln with ultra violet rays. In part (c) of FIG. 7, a step of increasing an amount of radiation of the ultra violet rays that are radiated from the second UV radiation unit 92 and a step of performing a main scan without discharging the UV ink from the discharge head 8, are included. The control unit 80 (refer to FIG. 1) moves the discharge head 8 relatively to a position at which the second UV radiation unit 92 overlaps with Lna and Lnb of the line Ln of the printing region T by performing a sub-scan, and stops the radiation of ultra violet rays from the first UV radiation unit 91.

Next, the control unit 80 (refer to FIG. 1) performs a main scan by radiating ultra violet rays from the second UV radiation unit 92 without discharging UV ink from the discharge head 8. At this time, an amount of radiation of the second UV radiation unit 92 in (or during) a main scan that radiates ultra violet rays from the second UV radiation unit 92 without discharging the UV ink from the discharge head 8 is greater than an amount of radiation of the second UV radiation unit 92 in a main scan that discharges the UV ink from the discharge head, and radiates ultra violet rays from the second UV radiation unit 92. In one example, the radiation from the second UV radiation unit 92 during the main scan associated with part (a) of FIG. 7 when UV ink is being discharged is less that radiation from the second UV radiation unit 92 during the main scan associated with part (d) of FIG. 7 when UV is not discharged from the discharge head 8 (because it is no longer over an area where an image is being formed).

Printing (the discharge of UV ink) on the target printing medium is ended by the main scan in part (b) of FIG. 7, which is a step that precedes part (c) of FIG. 7, but an amount of radiation of the ultra violet rays that are radiated from the second UV radiation unit 92 with respect to UV ink that is printed on Lnb of the line Ln is insufficient by two passes, and an amount of radiation of the ultra violet rays that are radiated from the second UV radiation unit 92 with respect to UV ink that is printed on Lna of the line Ln is insufficient by one pass. In such an instance, the control unit 80 (refer to FIG. 1) increases a light emission amount by increasing a current value of a power source that drives the light emitting element of the second UV radiation unit 92, and sets an amount of radiation of the ultra violet rays that are radiated from the second UV radiation unit 92 to double in one example. Next, the control unit 80 (refer to FIG. 1) performs a main scan of the discharge head 8 (the second UV radiation unit 92). As a result of this, in a single pass (main scan), it is possible to irradiate the UV ink that is printed on Lna and Lnb of the line Ln with an amount of radiation of the ultra violet rays that corresponds to two passes. The step of part (c) of FIG. 7 is referred to as a lower end process.

Part (d) of FIG. 7 shows a state in which printing including the lower end process has finished. The control unit 80 (refer to FIG. 1) performs a sub-scan of the discharge head 8, and printing is finished. The lower end process is also finished by stopping the radiation of ultra violet rays from the second UV radiation unit 92.

Additionally, in the present embodiment, a case of printing and radiating ultra violet rays of one line with two passes (main scans), and irradiating UV ink after printing with ultra violet rays using two passes (main scans) is shown as an example, but the invention is not limited to this example. In a case of irradiating UV ink after printing with ultra violet rays using n passes, it is possible to decrease a number of scans (a number of lower end processes) of a main scan that radiates ultra violet rays from the second UV radiation unit 92 without discharging the UV ink to 1/n as a result of setting an amount of radiation of the ultra violet rays that are radiated from the second UV radiation unit 92 to n times in the lower end process. In one example, the number of main scans necessary to perform the lower end processes can be reduced by increasing the amount of radiation from the second UV radiation unit 92.

In the abovementioned manner, according to the printing apparatus 1 of one embodiment, it is possible to obtain the following effects.

The printing apparatus 1 includes the first UV radiation unit 91 that discharges UV ink onto the target printing medium from the discharge head 8. Simultaneously, ultra violet rays are radiated (e.g., by the UV radiation unit 91). The second UV radiation unit 92 irradiates UV ink that is discharged onto the target printing medium with ultra violet rays. The printing apparatus 1 can increase an amount of radiation of the ultra violet rays that are radiated from the second UV radiation unit 92. By increasing an amount of radiation per unit time of the ultra violet rays in the lower end process, in which ultra violet rays is radiated to UV ink that is discharged onto the line of the lowermost end (e.g., Ln), by n times after discharging UV ink onto the lower end Tb of the printing region T of the target printing medium, it is possible to reduce a number of scans of a main scan that is performed in the lower end process to 1/n. For example, in a case in which two main scans are necessary in the lower end process, it is possible to complete the lower end process with one main scan by setting the amount of radiation of the ultra violet rays that are radiated from the second UV radiation unit 92 to double. As a result of this, a time that is required to perform the lower end process is reduced, and therefore, it is possible to improve a processing capacity of the printing apparatus 1. Therefore, it is possible to provide a printing apparatus 1 with an improved printing processing capacity.

In addition, a printing method in which printing is performed using the printing apparatus 1 includes, using the control unit 80, the step of increasing an amount of radiation of the ultra violet rays that is radiated from the second UV radiation unit 92 in the lower end process, in which ultra violet rays are radiated to UV ink that is discharged onto the line of the lowermost end, after discharging UV ink onto the lower end Tb of the printing region T of the target printing medium, and the step of performing a main scan by moving the discharge head 8 and the target printing medium relatively as a result of driving the main scan unit 7 without discharging the UV ink from the discharge head 8. As a result of this, since it is possible to reduce the number of scans (the number of lower end processes) for radiating ultra violet rays, a time that is required for the lower end process is reduced, and therefore, it is possible to improve a processing capacity of the printing apparatus 1. Therefore, it is possible to provide a printing method that improves the processing capacity of the printing apparatus 1.

Additionally, embodiments of the invention are not limited to the abovementioned embodiment, and it is possible to add various modifications and improvements and the like to the embodiment that is described above. Modification examples will be described below.

### Modification Example 1

A printing apparatus 100 according to modification example 1 differs from the embodiment in a feature of a second UV radiation unit 192 including a plurality of light emitting elements.

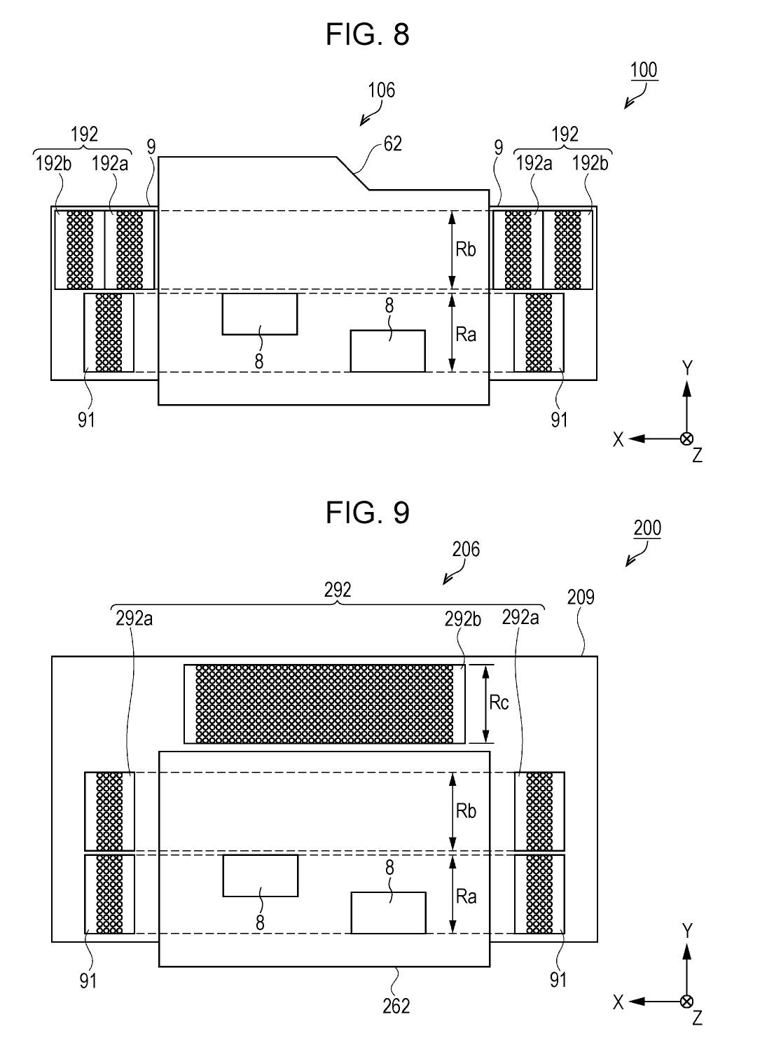

FIG. 8 is a plan view that shows a bottom surface (a −Z axis side) of a printing unit 106 of the printing apparatus 100 according to modification example 1. An overall configuration of the printing unit 106 according to modification example 1 will be described with reference to FIG. 8. Additionally, the same symbols will be associated with constituent parts that are the same as the printing apparatus 1, and overlapping description thereof will be omitted.

The printing unit 106 includes the carriage unit 62, and a UV radiation unit 9 that is respectively fixed to both sides of the carriage unit 62 in the main scanning direction (the X axis direction). The UV radiation unit 9 is provided with a first UV radiation unit 91 and a second UV radiation unit 192 that irradiate the UV ink with ultra violet rays. The second UV radiation unit 192 is provided on a downstream side of the discharge head 8 and the first UV radiation unit 91 in the sub-scanning direction (the Y axis direction), and irradiates a region that overlaps with the region Rb with ultra violet rays.

The second UV radiation unit 192 includes a plurality of light emitting elements 192a and 192b. In the present modification example, the light emitting elements 192a and 192b are further formed by a plurality of light emitting element groups. The second UV radiation unit 192 can increase an amount of radiation of the ultra violet rays by driving the light emitting element 192b in addition to the light emitting element 192a in a main scan that radiates ultra violet rays from the second UV radiation unit 192 without discharging UV ink from the discharge head 8.

In the abovementioned manner, according to the printing apparatus 100 of the present modification example, it is possible to obtain the following effects in addition to those of the abovementioned embodiment.

The second UV radiation unit 192 includes the plurality of light emitting elements 192a and 192b that output ultra violet rays. The printing apparatus 100 can easily increase an amount of radiation of the ultra violet rays by driving the light emitting element 192b in addition to the light emitting element 192a of the second UV radiation unit 192 in the lower end process, in which ultra violet rays are radiated to UV ink that is discharged onto the line of the lowermost end, after discharging UV ink onto the lower end Tb of the printing region T of the target printing medium. As a result of this, a time that is required for the lower end process is reduced.

### Modification Example 2

A printing apparatus 200 according to modification example 2 differs from the embodiment in a feature of a second UV radiation unit 292 including a radiation light source for the lower end process 292b.

FIG. 9 is a plan view that shows a bottom surface (a −Z axis side) of a printing unit 206 of the printing apparatus 200 according to modification example 2. An overall configuration of the printing unit 206 according to modification example 2 will be described with reference to FIG. 9. Additionally, the same symbols will be associated with constituent parts that are the same as the printing apparatus 1, and overlapping description thereof will be omitted.

The printing unit 206 includes a carriage unit 262, and a UV radiation unit 209 that is fixed to both sides of the carriage unit 262 in the main scanning direction (the X axis direction), and a downstream side (the +Y axis side) thereof in the sub-scanning direction (the Y axis direction). The UV radiation unit 209 is provided with a UV radiation unit 91 and a UV radiation unit 292 that irradiate the UV ink with ultra violet rays. In the present modification example, for the purpose of description, the UV radiation unit 91 will be referred to as a first UV radiation unit, and the UV radiation unit 292 will be referred to as a second UV radiation unit.

The second UV radiation unit 292 includes a plurality of radiation light sources 292a and 292b. The radiation light source 292a is provided on a downstream side of the discharge head 8 and the first UV radiation unit in the sub-scanning direction (the Y axis direction), and irradiates a region that overlaps with the region Rb with ultra violet rays. The radiation light source 292b is provided further on a downstream side of the radiation light source 292a, and irradiates a region that overlaps with a region Rc with ultra violet rays. Since the radiation light source 292b is provided in a wide region on a downstream side of the carriage unit 262 in the sub-scan direction, it is possible to dispose a large quantity of light emitting elements therein.

The radiation light source 292b is used in the lower end process that only radiates ultra violet rays in or during a main scan that does not discharge UV ink. The lower end process is performed by moving the line of the lowermost end of a target printing medium, on which the discharge of UV ink has finished, to the region Rc by performing a sub-scan, and performing a main scan while driving the radiation light source 292b. Since a larger quantity of light emitting elements are disposed in the radiation light source 292b than the radiation light source 292a, it is possible to greatly increase the amount of radiation of the ultra violet rays in the lower end process.

In the abovementioned manner, according to the printing apparatus 200 of the present modification example, it is possible to obtain the following effects in addition to those of the abovementioned embodiment.

The second UV radiation unit 292 is provided with the radiation light source for the lower end process 292b that only radiates ultra violet rays in a main scan that does not discharge UV ink. In one example, the second UV radiation unit 292 may be used when UV ink is not discharged because the discharging aspect of the printing operation has been completed. Because a large quantity of light emitting elements are disposed in the radiation light source 292b, it is possible to greatly increase the amount of radiation of the ultra violet rays. As a result of this, it is possible to greatly reduce a time that is required for the lower end process.

These examples illustrate that the lower end process can be completed more quickly, by way of example, by increasing a power with which the UV light is emitted. In other words, the same number of elements may emit more radiation. In another example, the number of light emitted elements may be increased. In another example, the second UV radiation light source may include multiple units that are disposed in the sub-scan direction with respect to each other, as shown in FIG. 9.

What is claimed is:

1. A printing apparatus comprising:
a discharge head that includes nozzles, wherein UV ink is discharged from the nozzles and cured by the radiation of ultra violet rays;
a main scan unit that moves the discharge head relatively along a main scanning direction with respect to a target printing medium;
a sub-scan unit that moves the discharge head relatively along a sub-scanning direction with respect to the target printing medium, wherein the sub-scanning direction intersects the main scanning direction; and
a UV radiation unit, which is provided on a downstream side of the discharge head in the sub-scanning direction,
wherein an amount of radiation radiated by the UV radiation unit during a main scan in which the UV ink is not discharged from the discharge head is greater than an amount of radiation radiated by the UV radiation unit during a main scan in which UV ink is discharged from the discharge head.

2. The printing apparatus according to claim 1,
wherein the UV radiation unit includes a light emitting element, and
wherein the amount of radiation of the ultra violet rays is increased by increasing a light emission amount of the light emitting element.

3. The printing apparatus according to claim 1,
wherein the UV radiation unit includes a plurality of light emitting elements, and
wherein the amount of radiation of the ultra violet rays is increased by increasing an element number of the light emitting elements.

4. The printing apparatus according to claim 1,
wherein the UV radiation unit includes a radiation light source that radiates the ultra violet rays during the main scan that does not discharge UV ink.

5. The printing apparatus according to claim 1,
wherein a number of scans of a main scan in which the amount of radiation of the ultra violet rays is increased by n times, and which radiates ultra violet rays from the UV radiation unit without discharging the UV ink, is decreased by 1/n.

6. A printing method in which printing is performed using a printing apparatus including
a discharge head having nozzles that discharge UV ink that is cured by the radiation of ultra violet rays,
a main scan unit that moves the discharge head relatively along a main scanning direction with respect to a target printing medium,
a sub-scan unit that moves the discharge head relatively along a sub-scanning direction with respect to the target printing medium, which sub-scanning direction intersects the main scanning direction, and
a UV radiation unit, which is provided on a downstream side of the discharge head in the sub-scanning direction,
the printing method comprising:
increasing an amount of radiation of the ultra violet rays that is radiated from the UV radiation unit; and
performing a main scan without discharging the UV ink from the discharge head while radiating with the increased amount of radiation.
